(19) United States
(12) Patent Application Publication
(10) Pub. No.: US 2003/0207974 A1
(43) Pub. Date: Nov. 6, 2003

(54) Tarnish inhibiting formula and tarnish inhibiting articles using same

(75) Inventors: Donald A. Kubik, Dickenson, ND (US); Boris G. Varshal, Lynn, MA (US); Efim Ya. Lyublinski, Mayfield Heights, OH (US); Barbara A. Nygaard, Circle Pines, MN (US)

Correspondence Address: Alfred D. Lobo, LOBO & CO., L.P.A., 933 The Leader Building, 526 Superior Avenue, E., Cleveland, OH, 44114-1902, US

(73) Assignee: Northern Technologies International Corporation, Beachwood, OH (US)

(21) Appl. No.: 10/453,303

(22) Filed: Jun. 3, 2003

Related U.S. Application Data
(63) Continuation of application No. 10/054,032, filed on Jan. 22, 2002, now abandoned.

(51) Int. Cl. C08K 3/18; C08K 3/34

(52) U.S. Cl. 524/430; 524/442

(57) ABSTRACT

The present invention relates to tarnish inhibiting formulas. More particularly, in one embodiment the present invention relates to tarnish inhibiting formulas which comprise a mixture of: (i) at least one carrier; (ii) at least one strong alkali compound; and (iii) at least one compound which yields an insoluble compound. These mixtures can further include one or more additional additives such as antioxidants, corrosion inhibitors, etc. In yet another embodiment, the tarnish inhibiting formulas (and in some cases corrosion inhibiting as well) according to the present invention can be placed in a suitable polymer film and/or polymer article.

### FIELD OF THE INVENTION

The present invention relates to tarnish inhibiting formulas. More particularly, in one embodiment the present invention relates to tarnish inhibiting formulas which comprise a mixture of: (i) at least one carrier; (ii) at least one strong alkali compound; and (iii) at least one compound which yields an insoluble compound (e.g., an insoluble sulfide). These mixtures can further include one or more additional additives such as antioxidants, corrosion inhibitors, etc.. In yet another embodiment, the tarnish inhibiting formulas (and in some cases corrosion inhibiting as well) according to the present invention can be placed in a suitable polymer film and/or polymer article.

### BACKGROUND OF THE INVENTION

In commerce and industry today, the useful life of corrodible items may be extended and/or preserved by providing corrosion inhibitors which protect the corrodible items from the adverse effects of its ambient environment. Among the common indications of corrosion manifested in useful metallic articles are oxidation, pitting, tarnishing, mottling, or discoloration of the surfaces of these items. These manifestations occur in metallic articles, particularly when exposed to oxygen, in either gaseous or liquid phase. Additionally, sulfides and/or chlorides (or chlorine) may cause corrosion or tarnishing problems as well.

Inasmuch as both oxygen and water, including water vapor, occur normally and are available in nature, it is normally necessary to take precautions against tarnishing and/or corrosion when packaging metallic items for shipment or storage, or when subjecting such items to normal use. Metals which are frequently found to be susceptible to tarnish and/or corrosion under normal atmospheric and ambient conditions include, but are not limited to, iron, copper, brass, aluminum, silver, and alloys of these metals.

### SUMMARY OF THE INVENTION

The present invention relates to tarnish inhibiting formulas. More particularly, in one embodiment the present invention relates to tarnish inhibiting formulas which comprise a mixture of: (i) at least one carrier; (ii) at least one strong alkali compound; and (iii) at least one compound which yields an insoluble sulfide. These mixtures can further include one or more additional additives such as antioxidants, corrosion inhibitors, etc. In yet another embodiment, the tarnish inhibiting formulas according to the present invention can be placed in a suitable polymer film and/or polymer article.

In another embodiment, the present invention relates to a tarnish inhibiting polymer article comprising: about one part to about ten parts of a tarnish inhibiting mixture contained in a carrier the tarnish inhibiting mixture comprising: (i) at least one carrier; (ii) at least one strong alkali compound; and (iii) at least one compound which yields an insoluble compound, and about ninety to about ninety-nine parts of at least one polymer composition and/or resin composition.

To the accomplishment of the foregoing and related ends, the invention, then, comprises the features hereinafter fully described and particularly pointed out in the claims. These embodiments are indicative, however, of but a few of the various ways in which the principles of the invention may be employed. Other objects, advantages and features of the invention will become apparent from the following detailed description of the invention.

### DETAILED DESCRIPTION OF THE INVENTION

As noted above, The present invention relates to tarnish inhibiting formulas. More particularly, in one embodiment the present invention relates to tarnish inhibiting formulas which comprise a mixture of: (i) at least one carrier; (ii) at least one strong alkali compound; and (iii) at least one compound which yields an insoluble sulfide. These mixtures can further include one or more additional additives such as antioxidants, corrosion inhibitors, etc.. In yet another embodiment, the tarnish and, in some cases, corrosion inhibiting formulas according to the present invention can be placed in a suitable polymer film and/or polymer article.

In yet another embodiment, if desired, such mixtures are combined with an additional amount of a suitable polymer or resin material and further processed (e.g., by extrusion, co-extrusion, coating, casting, etc.) to form a polymer film or polymer article.

Additionally, it should be noted that in the following text, where utilized, range and ratio limits may be combined.

Carrier:

Any suitable carrier can be utilized to form the tarnish and, in some cases, corrosion inhibiting mixtures discussed above. Exemplary carriers include, but are not limited to, polymer and/or resin compositions (e.g., polyolefin polymers, biodegradable polymers, acrylic polymers, etc.) a polymer gel (e.g., mixture of a suitable polymer and water), a wax (e.g., paraffin) and silica gels.

Polymer:

In one embodiment, the tarnish inhibiting formula according to the present invention comprises a mixture of: (i) at least one carrier; (ii) at least one strong alkali compound; and (iii) at least one compound which yields an insoluble sulfide. These mixtures can further include one or more additional additives such as antioxidants, corrosion inhibitors, etc.

As previous discussed, this mixture can, if desired, be combined with a suitable amount of additional polymer or resin and further processed by known techniques (e.g., extrusion, co-extrusion, coating, casting, etc.) to produce a polymer film or polymer article. The polymer used for the carrier portion can be identical to or different from that utilized for the polymer article forming portion.

In one embodiment, suitable polymers for either the carrier or the polymer article forming portion include polyolefin polymers and co-polymers of polyolefins. Exemplary polyolefins include, but are not limited to, polyethylenes, polypropylenes, polybutenes, polyisoprenes. In another embodiment, polymers such as ethylene/vinyl acetate copolymers, ethylene/vinyl chloride copolymers, polyvinyl chloride polymers, polyurethane polymers, polyester polymers, polyacrylic polymers (both crosslinked and non-crosslinked) and copolymers of one or more of the above can be utilized in the present invention as a carrier. Such copolymers could include two or more of the same type of monomers, for example, two or more different olefins.

In yet another embodiment, the carrier and/or polymer article forming portion for the afore-mentioned corrosion inhibiting mixture is a bio-degradable polymer. Any polymer which exhibits biodegradability can be utilized in conjunction with the present invention. Examples of suitable bio-degradable polymers include, but are not limited to, biodegradable polyesters (e.g., linear poly ε-carpolactone (PCL)), biodegradable polylatic acid polymers, biodegradable polyester amide polymers, biodegradable polyester urethane polymers and biodegradable copolymers of any combination of two or more of the above. Such copolymers could include two or more of the same type of polymer, for example, two or more different biodegradable polyesters.

Furthermore, the afore-mentioned tarnish inhibiting mixture can be added to an additional amount of some or all of the above polymer compositions and further processed by known techniques (e.g., extrusion, co-extrusion, blow molding, etc.) to produce a polymer film or polymer article which contains therein a tarnish inhibiting mixture.

U.S. Pat. Nos. 5,801,224 and 5,969,089 disclose aliphatic polyesters which are formed by a bulk extrusion polymerization process. These two patents are hereby incorporated by reference in their entirety for the disclosure regarding polyester polymers and their teachings as to how to produce same. The polymers disclosed in U.S. Pat. Nos. 5,801,224 and 5,969,089 can be utilized in the present invention both as a carrier and as a final polymer medium for the above-mentioned tarnish inhibiting mixture.

In one embodiment, the weight ratio of compounds (ii) and (iii) to the carrier component (i) in the tarnish inhibiting mixture is from about 1:1 to about 1:100, or from about 1:10 to about 1:80, or even from about 1:20 to about 1:60. In another embodiment, the weight ratio of compounds (ii) and (iii) to the carrier component (i) in the tarnish inhibiting mixture is from about 1:1 to about 1:10, or from about 1:2 to about 1:8, or even from about 1:3 to about 1:7.

The tarnish inhibiting mixtures are produced by mixing all of the components (i) to (iii) together and extruding the mixture at a temperature of above about 150° F., or above about 200° F., or even above about 250° F.

Strong Alkali Compound:

Any suitable Group 1 or 2 silicate or oxide can be utilized in the present invention as component (ii), the at least one strong alkali compound. Exemplary silicates include lithium silicate, sodium silicate, potassium silicate and barium silicate. With regard to the silicates utilized in the present invention, the weight ratio of alkali or alkaline-earth metal oxide to silicate can vary. In one embodiment, this ratio of metal oxide to silicate is from about 5:1 to about 1:5, in another the weight ratio is from about 2.5:1 to about 1:2.5.

In another embodiment, a mixture of one or more silicates can be used in the present invention. In yet another embodiment, the one or more silicates can be in a glassy or crystalline state.

In yet another embodiment, at least one alkali or alkaline-earth metal oxide is utilized in the present invention rather than the one or more silicate. Exemplary alkaline-earth metal oxides include, but are not limited to, magnesium oxide, calcium oxide, strontium oxide and barium oxide. In another embodiment, a mixture of two or more alkali or alkaline-earth metal oxides can be utilized in the present invention.

While not wishing to be bound to any one theory, it is believed that the one or more strong alkali compounds react with any hydrogen sulfide (H₂S) and any acid compounds present in the environment. This prevents such compounds from passing through the polymer matrix of a polymer article which contains therein a tarnish inhibiting formula according to the present invention.

Compounds Which Yield Insoluble Compounds:

Any suitable compound which forms an insoluble compound such as a sulfide (solubility of less than about 0.1 grams/liter of water) can be utilized in the present invention as component (iii), the at least one compound which yields an insoluble sulfide. Exemplary compounds include, but are not limited to, compounds containing iron, cobalt, nickel, copper and zinc. Mixtures of two or more such compounds can also be utilized in the present invention. Suitable anions for the at least one compound according to component (iii) include oxides and hydroxides.

Exemplary compounds include, but are not limited to, zinc oxide, zinc hydroxide, iron oxides (both ferrous oxide and ferric oxide), iron hydroxide (Fe(OH)₂), cobalt oxide, cobalt hydroxides (both Co(OH)₂ and Co₂O₃•3H₂O), nickel oxide, nickel (II) hydroxide, copper oxides (both cuprous oxide and cupric oxide) and copper hydroxide. Mixtures of two or more of the above compounds can also be utilized as component (iii).

Volatile Corrosion Inhibitors:

In one embodiment, the present invention further includes any suitable volatile corrosion inhibitor (or vapor phase corrosion inhibitor) can be utilized in the present invention. Some suitable volatile corrosion inhibitors are disclosed in U.S. Pat. Nos. 4,290,912; 5,320,778; and 5,855,975, which are all incorporated herein by reference in their entirety for their teachings of such compounds. For example, useful vapor phase or volatile corrosion inhibitors include, but are not limited to, triazoles and/or inorganic nitrites (e.g., nitrite salts).

Exemplary inorganic nitrite salts include, but are not limited to, metal nitrites such as sodium nitrite, potassium nitrite and barium nitrite. In another embodiment, any suitable Group 1 or Group 2 nitrite (New Notation System) can be used in the present invention.

In another embodiment, the one or more optional vapor phase or volatile corrosion inhibitor utilized in the present invention can be a triazole. Exemplary triazoles include, but are note limited to, benzotriazole, tolyltriazole and/or sodium tolyltriazole.

In yet another embodiment, the optional vapor phase or volatile corrosion inhibitor utilized in the present invention can be any suitable mixture of two or more of the above-mentioned volatile corrosion inhibitors.

Antioxidants:

If desired, any suitable antioxidant can be utilized in the present invention. Exemplary antioxidants include, but are not limited to, tri-substituted phenols substituted in the 2, 4 and 6 positions with one or more alkyl, hydroxyalkyl, aryl, alkenyl or hydroxyalkenyl groups of the general formula shown below.

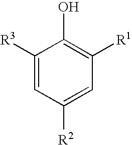

In one embodiment, the sum of the carbon atoms present in the substituent groups R¹, R² and R³ is in the range of 3 to about 36, or even in the range of 3 to about 18.

In another embodiment, a mixture of two or more of the above-mentioned antioxidants can be utilized in the present invention.

Additional Additives:

In addition to components (i) to (iii), the tarnish inhibiting mixtures of the present invention can optionally include processing aids such as plasticizers (e.g., dioctyl phthalate, tricrecyl phosphate, etc.) and/or other additives such as fillers, colorants, slip agents, lubricants, tackifiers, anti-bacterials, anti-statics, anti-mildew agents, anti-settling agents, UV-protectants, insecticides, pesticides, oils (including biodegradable oils), etc.

Biodegradable oils include, but are not limited to fish oils, vegetable oils, lanolins, synthetic esters, low molecular weight polyalfaolefins, polybutenes and polyalkylene glycols. Examples of suitable vegetable oils include, but are not limited to, rapeseed oil, canola oil, soybean oil, corn oil, cottonseed oil, linseed oil, olive oil, tung oil, peanut oil, meadowfoam oil, sunflower oil, safflower oil, jojoba oil, palm oil, castor oil, among others.

In another embodiment, when an oil is added to a tarnish inhibiting mixture according to the present invention an anti-settling agent is utilized to prevent the tarnish inhibiting mixture from settling out. Such a combination yields a tarnish inhibiting oil mixture which can be applied to various articles. As noted above, in some instances a tarnish inhibiting mixture according to the present invention can also inhibit corrosion.

In one embodiment, the tarnish inhibiting mixtures of the present invention are acid-free (i.e., the mixtures contain no acidic compounds). For example, in one embodiment, acid free can mean having a pH of more than about 5, or more than about 6, or even more than about 7.

In another embodiment, a tarnish inhibiting mixture according to the present invention optionally contains an odor-suppressing compound. Such compounds include, but are not limited to, iron oxides (both ferrous oxide and ferric oxide), cobalt oxide, nickel oxide, copper oxides (both cuprous oxide and cupric oxide), zinc oxide, magnesium oxide and calcium oxide.

In yet another embodiment, a tarnish inhibiting mixture according to the present invention can be added to a biodegradable solvent. Biodegradable solvents are known in the art and as such a discussion hereof is omitted. Such a mixture can optionally include an anti-settling agent if necessary to keep the tarnish inhibiting mixture according to the present invention from “settling out”.

### EXAMPLES

The present invention is further illustrated by the following examples wherein the term parts refers to parts by weight unless otherwise indicated. The following examples are not meant to be limiting, rather the are illustrative of only a few embodiments within the scope of the present invention.

### Example 1

(a) The follow compounds are mixed uniformly to form a tarnish inhibiting mixture.

| | |
|---|---|
| Sodium Silicate¹ | 25 parts |
| Zinc Oxide | 25 parts |
| “Microthene FE-532” organic polymer² | 50 parts |

¹Sodium Silicate is a glassy product with a weight ratio of silica to sodium oxide of 2 (commercially available from the PQ Corporation).
²“Microthene FE-532” is ethylene/vinyl acetate copolymer (commercially available from U.S. Industrial Chemical Corporation).

The concentrate formed by extruding the mixture above about 250° F. shows little degradation.

(b) Four different films which contain the above tarnish inhibiting mixture are formed by uniformly mixing the following ingredients.

| Ingredients | Film 1 | Film 2 | Film 3 | Film 4 |
|---|---|---|---|---|
| Tarnish | 2 parts | 3 parts | 4 parts | 5 parts |
| Inhibiting | | | | |
| Mixture of | | | | |
| Example 1 | | | | |
| Low Density | 98 parts | 97 parts | 96 parts | 95 parts |
| Polyethylene | | | | |

The mixtures are extruded and blown into films at a temperature of at least about 300° F. The resultant films show no discoloration or gas formation. The films are tested using the following method.

Silver coupons are sealed in a bag made of each of the above Films 1 to 4. The test bags made of Films 1 to 4 are then exposed in a container to an environment containing H₂S and 100% humidity. A control is also utilized. The control is a bag made of plain polyethylene with the same thickness as Films 1 to 4. The silver coupons sealed in the bag made of plain polyethylene with the same thickness are exposed to the same container in order to serve as a control. The coupons are subjected to this environment for at least about 4 hours.

It should be noted, that prior to beginning the test procedure, the silver coupons must be clean, free of tarnish and other deposits.

The results of each of the films are judged by the final state of the coupons that are contained therein. First, the coupons are checked by the “naked” eye for any visible tarnishing. Next, the coupons are checked by the “naked” eye for any other corrosive effects such as mottling or discoloration of one or more surfaces of the coupons.

Based on the above test, the films with at least a 2% concentration of the above-mentioned tarnish inhibiting mixture are found to possess excellent anti-tarnish properties.

### Example 2

(a) The follow compounds are mixed uniformly to form a tarnish inhibiting mixture.

| | |
|---|---|
| Potassium Silicate³ | 25 parts |
| Zinc Oxide | 25 parts |
| “Microthene FE-532 organic polymer² | 50 parts |

³Potassium Silicate is a glassy product with a weight ratio of silica to potassium oxide of 2.5 (commercially available from the PQ Corporation).

The concentrate formed by extruding the mixture above about 250° F. shows little degradation.

(b) Four different films which contain the above tarnish inhibiting mixture are formed by uniformly mixing the following ingredients.

| Ingredients | Film 5 | Film 6 | Film 7 | Film 8 |
|---|---|---|---|---|
| Tarnish | 2 parts | 3 parts | 4 parts | 5 parts |
| Inhibiting | | | | |
| Mixture of | | | | |
| Example 2 | | | | |
| Low Density | 98 parts | 97 parts | 96 parts | 95 parts |
| Polyethylene | | | | |

The mixtures are extruded and blown into films at a temperature of at least about 300° F. The resultant films show no discoloration or gas formation. The films are tested using the following method.

The above described silver coupon test of Example 1 is conducted with Films 5 to 8 and based on the test of Example 1, the films with at least a 3% concentration of the above-mentioned tarnish inhibiting mixture are found to possess excellent anti-tarnish properties.

### Example 3

(a) The follow compounds are mixed uniformly to form a tarnish inhibiting mixture.

| | |
|---|---|
| Calcium Oxide | 25 parts |
| Zinc Oxide | 25 parts |
| “Microthene FE-532” organic polymer² | 50 parts |

The concentrate formed by extruding the mixture above about 250° F. shows little degradation.

(b) Four different films which contain the above tarnish inhibiting mixture are formed by uniformly mixing the following ingredients.

| Ingredients | Film 9 | Film 10 | Film 11 | Film 12 |
|---|---|---|---|---|
| Tarnish | 2 parts | 3 parts | 4 parts | 5 parts |
| Inhibiting | | | | |
| Mixture of | | | | |
| Example 3 | | | | |
| Low Density | 98 parts | 97 parts | 96 parts | 95 parts |
| Polyethylene | | | | |

The mixtures are extruded and blown into films at a temperature of at least about 300° F. The resultant films show no discoloration or gas formation. The films are tested using the following method.

The above described silver coupon test of Example 1 is conducted with Films 11 to 12 and based on the test of Example 1, the films with at least a 4% concentration of the above-mentioned tarnish inhibiting mixture are found to possess excellent anti-tarnish properties.

### Example 4

(a) The follow compounds are mixed uniformly to form a tarnish inhibiting mixture.

| | |
|---|---|
| Sodium Metasilicate⁴ | 25 parts |
| Zinc Oxide | 25 parts |
| “Microthene FE-532” organic polymer | 50 parts |

⁴Sodium Metasilicate is a partly glassy and partly crystalline product with a weight ratio of silica to sodium oxide of 1 (commercially available from Occidental Chemical Corporation).

The concentrate formed by extruding the mixture above about 250° F. shows little degradation.

(b) Four different films which contain the above tarnish inhibiting mixture are formed by uniformly mixing the following ingredients.

| Ingredients | Film 13 | Film 14 | Film 15 | Film 16 |
|---|---|---|---|---|
| Tarnish | 2 parts | 3 parts | 4 parts | 5 parts |
| Inhibiting | | | | |
| Mixture of | | | | |
| Example 4 | | | | |
| Low Density | 98 parts | 97 parts | 96 parts | 95 parts |
| Polyethylene | | | | |

The mixtures are extruded and blown into films at a temperature of at least about 300° F. The resultant films show no discoloration or gas formation. The films are tested using the following method.

The above described silver coupon test of Example 1 is conducted with Films 13 to 16 and based on the test of Example 1, the films with at least a 2% concentration of the above-mentioned tarnish inhibiting mixture are found to possess excellent anti-tarnish properties.

### Example 5

(a) The follow compounds are mixed uniformly to form a tarnish inhibiting mixture.

| | |
|---|---|
| Sodium Silicate | 25 parts |
| Zinc Oxide | 20 parts |
| “Cobratec TT-85”⁵ | 5 parts |
| “Microthene FE-532” organic polymer | 50 parts |

⁵“Cobratec TT-85” is sodium tolyltriazole, corrosion inhibitor (commercially available from the Sherwin-Williams Company).

The concentrate formed by extruding the mixture above about 250° F. shows little degradation.

(b) Four different films which contain the above tarnish inhibiting mixture are formed by uniformly mixing the following ingredients.

| Ingredients | Film 17 | Film 18 | Film 19 | Film 20 |
|---|---|---|---|---|
| Tarnish | 2 parts | 3 parts | 4 parts | 5 parts |
| Inhibiting | | | | |
| Mixture of | | | | |
| Example 5 | | | | |
| Low Density | 98 parts | 97 parts | 96 parts | 95 parts |
| Polyethylene | | | | |

The mixtures are extruded and blown into films at a temperature of at least about 300° F. The resultant films show no discoloration or gas formation. The films are tested using the following method.

The above described silver coupon test of Example 1 is conducted with Films 13 to 16 and based on the test of Example 1, the films with at least a 2% concentration of the above-mentioned tarnish inhibiting mixture are found to possess excellent anti-tarnish properties.

### Example 6

(a) The follow compounds are mixed uniformly to form a tarnish inhibiting mixture.

| | |
|---|---|
| Sodium Silicate | 25 parts |
| Zinc Oxide | 25 parts |
| Polymer PCL⁶ | 50 parts |

⁶Polymer PCL is biodegradable aliphatic polyester polymer. PCL is fully biodegradable polyester and passes the ASTM and IS0 Standards of biodegradability and compostability (commercially available from Dow Chemical Corporation).

The concentrate formed by extruding the mixture above about 200° F. shows little degradation.

(b) Four different films which contain the above tarnish inhibiting mixture are formed by uniformly mixing the following ingredients.

| Ingredients | Film 21 | Film 22 | Film 23 | Film 24 |
|---|---|---|---|---|
| Tarnish | 2 parts | 3 parts | 4 parts | 5 parts |
| Inhibiting | | | | |
| Mixture of | | | | |
| Example 6 | | | | |
| Polymer PCL⁶ | 98 parts | 97 parts | 96 parts | 95 parts |

The mixtures are extruded and blown into films at a temperature of at least about 250° F. The resultant films show no discoloration or gas formation. The films are tested using the following method.

The above described silver coupon test of Example 1 is conducted with Films 21 to 24 and based on the test of Example 1, the films with at least a 2% concentration of the above-mentioned tarnish inhibiting mixture are found to possess excellent anti-tarnish properties.

Although the present invention has been shown and described with respect to certain embodiments, it is obvious that equivalent alterations and modifications will occur to others skilled in the art upon the reading and understanding of this specification. In particular with regard to the various functions performed by the above described components, the terms (including any reference to a “means”) used to describe such components are intended to correspond, unless otherwise indicated, to any component which performs the specified function of the described component (e.g., that is functionally equivalent), even though not structurally equivalent to the disclosed structure which performs the function in the herein illustrated exemplary embodiments of the invention. In addition, while a particular feature of the invention may have been disclosed with respect to only one of several embodiments, such feature may be combined with one or more other features of the other embodiments as may be desired and advantageous for any given or particular application.

What is claimed is:

1. A tarnish inhibiting mixture comprising the following components:
(i) at least one carrier;
(ii) at least one strong alkali compound; and
(iii) at least one compound which yields an insoluble compound.

2. The tarnish inhibiting mixture of claim 1, wherein the carrier is selected from at least one polymer composition, at least one resin composition, at least one polymer gel, at least one wax, silica gels and combinations of two or more thereof.

3. The tarnish inhibiting mixture of claim 2, wherein the at least one carrier is a polyolefin polymer or copolymer.

4. The tarnish inhibiting mixture of claim 3, wherein the at least one carrier is at least one polymer selected from polyethylene polymers, polypropylene polymers, polybutenes polymers, polyisoprene polymers and copolymers of two or more thereof.

5. The tarnish inhibiting mixture of claim 3, wherein the at least one carrier is at least one polymer selected from ethylene/vinyl acetate copolymers, ethylene/vinyl chloride copolymers, polyvinyl chloride polymers, polyurethane polymers, polyester polymers, polyacrylic polymers and copolymers of two or more of the above.

6. The tarnish inhibiting mixture of claim 3, wherein the at least one carrier is at least one biodegradable polymer or copolymer.

7. The tarnish inhibiting mixture of claim 6, wherein the biodegradable polymer or copolymer is selected from biodegradable polyesters, biodegradable polylatic acid polymers, biodegradable polyester amide polymers, biodegradable polyester urethane polymers and biodegradable copolymers of any combination of two or more of the above.

8. The tarnish inhibiting mixture of claim 6, wherein the biodegradable polymer is linear poly ε-carpolactone.

9. The tarnish inhibiting mixture of claim 1, wherein component (ii) is selected from at least one Group 1 silicate, Group 1 oxide, Group 2 silicate, Group 2 oxide and mixtures of two or more thereof.

10. The tarnish inhibiting mixture of claim 9, wherein the at least one Group 1 and/or Group 2 silicates and oxides are selected from lithium silicate, sodium silicate, potassium silicate, barium silicate, magnesium oxide, calcium oxide, strontium oxide, barium oxide and mixtures of two or more thereof.

11. The tarnish inhibiting mixture of claim 1, wherein component (iii) is selected from one or more of zinc oxide, zinc hydroxide, iron oxides, iron hydroxide, cobalt oxide, cobalt hydroxides, nickel oxide, nickel (II) hydroxide, copper oxides, copper hydroxide and mixtures of two or more thereof.

12. The tarnish inhibiting mixture of claim 1, further comprising at least one vapor phase or volatile corrosion inhibitor.

13. The tarnish inhibiting mixture of claim 12, wherein the at least one vapor phase or volatile corrosion inhibitor is selected from inorganic nitrite salts, triazole compounds and mixtures of two or more thereof.

14. The tarnish inhibiting mixture of claim 13, wherein the at least one vapor phase or volatile corrosion inhibitor is selected from sodium nitrite, potassium nitrite, barium nitrite and mixtures of two or more thereof.

15. The tarnish inhibiting mixture of claim 13, wherein the at least one vapor phase or volatile corrosion inhibitor is selected from benzotriazole, tolyltriazole, sodium tolyltriazole and mixtures of two or more thereof.

16. The tarnish inhibiting mixture of claim 13, wherein the at least one vapor phase or volatile corrosion inhibitor is selected from tri-substituted phenols substituted in the 2, 4 and 6 positions with one or more alkyl, hydroxyalkyl, aryl, alkenyl or hydroxyalkenyl groups having the general formula: 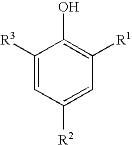
wherein the sum of the carbon atoms present in the substituent groups R¹, R² and R³ is in the range of 3 to about 36.

17. The tarnish inhibiting mixture of claim 13, wherein the at least one vapor phase or volatile corrosion inhibitor is selected from tri-substituted phenols substituted in the 2, 4 and 6 positions with one or more alkyl, hydroxyalkyl, aryl, alkenyl or hydroxyalkenyl groups having the general formula: 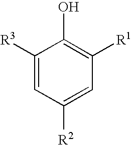
wherein the sum of the carbon atoms present in the substituent groups R¹, R² and R³ is in the range of 3 to about 18.

18. The tarnish inhibiting mixture of claim 1, further comprising at least one plasticizer, filler, colorant, slip agent, lubricant, tackifier, anti-bacterial, anti-static, anti-mildew agent, anti-settling agent, UV-protectant, insecticide, pesticide, oil or mixtures of two or more thereof.

19. A tarnish inhibiting polymer article comprising:
about one part to about ten parts of a tarnish inhibiting mixture contained in a carrier the tarnish inhibiting mixture comprising:
(i) at least one carrier;
(ii) at least one strong alkali compound; and
(iii) at least one compound which yields an insoluble compound, and about ninety to about ninety-nine parts of at least one polymer composition or resin composition.

20. The tarnish inhibiting polymer article of claim 19, which comprises about one part to about five parts of the tarnish inhibiting mixture contained in the carrier and about ninety-five to about ninety-nine parts of at least one polymer composition or resin composition.

21. The tarnish inhibiting polymer article of claim 19, which is a film.
